(19) United States
(12) Patent Application Publication
(10) Pub. No.: US 2009/0277273 A1
(43) Pub. Date: Nov. 12, 2009

(54) APPARATUS FOR MEASURING PRESSURE IN A VESSEL USING ACOUSTIC IMPEDANCE MATCHING LAYERS

(76) Inventors: Seung Soo HONG, Daejeon (KR); Yong Hyeon SHIN, Daejeon (KR); Bongyoung AHN, Daejeon (KR); Seung Hyun CHO, Gunpo-si (KR); Ki-Bok KIM, Daejeon (KR)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 12/190,350

(22) Filed: Aug. 12, 2008

(30) Foreign Application Priority Data
May 6, 2008 (KR) 10-2008-41716

(51) Int. Cl. G01N 29/14

(52) U.S. Cl. 73/632

(57) ABSTRACT

The apparatus for measuring pressure inside a vessel using acoustic impedance matching layers may include an ultrasound exciting unit attached to the outer surface of the vessel wall that generates ultrasonic waves inside of the vessel. A first acoustic impedance matching layer attached to the inner surface of the vessel wall increases the transmitting efficiency of the ultrasonic waves. An ultrasound receiving unit attached to the outer surface of the vessel wall receives an ultrasonic signal traveling inside the vessel. A second acoustic impedance matching layer attached to the inner surface of the vessel wall increases the transmitting efficiency of the ultrasonic waves. A control unit connected to the ultrasound exciting unit controls the excitation signal transmitted into the ultrasound exciting unit. A pressure measuring unit connected to the control unit measures an internal pressure of the vessel based on the excitation signal and the received ultrasonic waves.

The application claims the benefit of Korean Patent Application No. 10-2008-41716 filed May 6, 2008.

### FIELD OF THE INVENTION

The present invention relates to an apparatus for measuring pressure inside a vessel using acoustic impedance matching layers and, more particularly, to an apparatus which has acoustic impedance matching layers attached to the inner surface of the wall inside a vessel whose pressure is desired to be measured, thereby increasing the transmitting efficiency of ultrasonic waves necessary for pressure measurement to thereby improve accuracy, and which can measure pressure in a low or high vacuum state and even in a high pressure state.

### BACKGROUND OF THE RELATED ART

In general, in various manufacturing process such as the semiconductor and LCD fabrication, the measurement of the internal pressure of a vessel plays an important role in parameter control in process. When it is sought to measure the degree of vacuum, that is, the pressure of a vessel, a capacitance diaphragm gauge (CDG) is generally used.

This capacitance diaphragm gauge adopts a method of disposing the gauge inside a vessel to be measured and measuring the pressure of the vessel. However, this method using the capacitance diaphragm gauge was complicated in that, before the degree of vacuum (pressure) inside the vessel is measured, the degree of leakage of vacuum must be checked and, after the capacitance diaphragm gauge is disposed, the inside of the vessel must be made vacuum-tight. Further, the capacitance diaphragm gauge has limits that it is efficient for a low vacuum state.

To measure pressure in a high vacuum region an ionization gauge is usually employed. The ionization gauge is based on the principle that, when pressure is changed, a probability that electrons may collide against gas molecules increases, and the number of generated positive ions changes when the electrons collide against the gas molecules. The ionization gauge can measure pressure in the range of high vacuum regions of 10⁻¹ Pa to 10⁻¹⁰ Pa, but has a problem that linearity cannot be guaranteed below 10⁻⁶ Pa.

As for high pressure gauges, pressure in a limited small pressure chamber of various ultra-high pressure generators must be measured directly. An ultra-high pressure is generated by compressing a sample by application of a force to a sample compression device, such as a piston-cylinder type, using a hydraulic pressure device. Accordingly, an average pressure of the sample can be found by dividing the magnitude of applied force by a cross section of the sample chamber cross section. However, if this method is used, pressure distributions inside a gasket for sealing a sample are not constant, loss of a force due to friction is increased, and therefore pressure values are only approximately estimated.

As described above, there is a problem in that a pressure measuring apparatus in which an approximate degree of vacuum of a vessel is taken into consideration has to be selected and installed every time. Further, measurement methods are changed, resulting in inconvenience in use.

An apparatus for minimizing the leakage of a vessel and obviating inconvenience in checking the degree of leakage includes a pressure measuring apparatus having an ultrasonic transducer disposed outside a vessel. In general, a vessel is made of metal, such as stainless steel, so as to withstand the pressure difference between the inside and the outside of the vessel. Thus, if it is sought to transmit ultrasonic waves from the outside into the inside of the vessel in order to measure pressure inside the vessel, there is a problem in that ultrasound cannot be transmitted to gas inside the vessel since the difference of acoustic impedance between the vessel wall and the internal gas is relatively large. For a similar reason, there is also a problem in that the ultrasonic waves traveling in the gas inside the vessel, can hardly be transmitted to the vessel wall due to the difference of acoustic impedance. Therefore, there is a disadvantage in that the transmitting efficiency of ultrasonic waves from the outside into the inside or from the inside to the outside of a vessel is very low, which makes it difficult to measure pressure of a gas inside the vessel using ultrasonic waves. Accordingly, there is a need for an apparatus which is able to effectively transmit ultrasonic waves into the inside of a vessel in order to measure pressure of a gas in the vessel using the ultrasonic waves.

### SUMMARY OF THE INVENTION

Accordingly, the present invention has been made in view of the above problems occurring in the prior art, and an object of the present invention is to increase the transmitting efficiency of ultrasonic waves, from outside toward the inside of a vessel by using acoustic impedance matching layers. Further, the present invention provides a pressure measuring apparatus which can expect high resolution and improved accuracy and measure pressure inside a vessel even in a high vacuum, by increasing the transmitting efficiency of ultrasonic waves into the inside of the vessel. Furthermore, the present invention provides an apparatus that is able to measure pressure inside a vessel in a low vacuum state and even in a high pressure state over atmospheric pressure using one pressure measuring apparatus.

To accomplish the above object, in one aspect, the preset invention provides a pressure measuring apparatus using acoustic impedance matching layers including: an ultrasound exciting unit attached to the outer surface of the vessel wall for generating ultrasonic waves to an inside of the vessel; a first acoustic impedance matching layer attached to an inner surface of the vessel wall for increasing a transmitting efficiency of the ultrasonic waves generated from the ultrasound exciting unit into the inside of the vessel; an ultrasound receiving unit attached to the outer surface of the vessel wall for receiving the ultrasonic waves transmitted from the inside of the vessel; a second acoustic impedance matching layer attached to an inner surface of the vessel wall for increasing transmitting efficiency of the ultrasonic waves received by the ultrasound receiving unit; a control unit connected to the ultrasound exciting unit for controlling the excitation signal transmitted into the ultrasound exciting unit; and a pressure measuring unit connected to the control unit for measuring an internal pressure of the vessel based on the excitation signal, which are transmitted into the ultrasound exciting unit, and an ultrasonic waves received by the ultrasound receiving unit.

Further, the ultrasound exciting unit and the ultrasound receiving unit are preferably placed on the same axial line.

In addition, the first acoustic impedance matching layer or the second acoustic impedance matching layer comprises a single layer or a plurality of layers with different acoustic impedance.

Further, the first acoustic impedance matching layer or the second acoustic impedance matching layer has an acoustic impedance value between an acoustic impedance value of the vessel and an acoustic impedance value of gas inside the vessel.

Further, the control unit can control the excitation signal transmitted into the ultrasound exciting unit such that the ultrasonic waves generated from the ultrasound exciting unit resonate between the first acoustic impedance matching layer and the second acoustic impedance matching layer.

Moreover, each of the ultrasound exciting unit and the ultrasound receiving unit comprises a piezoelectric ultrasonic transducer, a magnetostrictive ultrasonic transducer, an electromagnetic ultrasonic transducer or an electrostrictive ultrasonic transducer.

In another aspect, the present invention provides a pressure measuring apparatus using an acoustic impedance matching layer including: an ultrasound exciting/receiving unit attached to the outer surface of the vessel wall, wherein the ultrasound exciting/receiving unit generates ultrasonic waves to an inside of the vessel and receives the ultrasonic waves, which are reflected from an inner wall of the vessel and then return back thereto; an acoustic impedance matching layer attached to the inner surface of the vessel wall for increasing a transmitting efficiency of the ultrasonic waves when ultrasonic waves are transmitted into or received from the inside of the vessel; a control unit coupled to the ultrasound exciting/receiving unit for controlling the excitation signal transmitted into the ultrasound exciting/receiving unit; and a pressure measuring unit connected to the control unit for measuring an internal pressure of the vessel based on the excitation signal transmitted into the ultrasound exciting/receiving unit and an ultrasonic waves received by the ultrasound exciting/receiving unit.

A reflection plate for reflecting the ultrasonic waves generated from the ultrasound exciting/receiving unit is further included inside the vessel.

Further, the ultrasound exciting/receiving unit comprises a piezoelectric ultrasonic transducer, a magnetostrictive ultrasonic transducer, an electromagnetic ultrasonic transducer or an electrostrictive ultrasonic transducer.

Further, the acoustic impedance matching layer can include a single layer or a plurality of layers with different acoustic impedance.

Further, the acoustic impedance matching layer has an acoustic impedance value between an acoustic impedance value of the vessel and an acoustic impedance value of gas inside the vessel.

The control unit can control the excitation signal transmitted into the ultrasound exciting/receiving unit such that the ultrasonic waves generated from the ultrasound exciting/receiving unit resonate between the acoustic impedance matching layer and the inner wall of the vessel or such that the ultrasonic waves generated from the ultrasound exciting/receiving unit resonate between the acoustic impedance matching layer and the reflection plate.

### BRIEF DESCRIPTION OF THE DRAWINGS

Further objects and advantages of the invention can be more fully understood from the following detailed description taken in conjunction with the accompanying drawings in which:

FIG. 1 shows the construction of a pressure measuring apparatus using acoustic impedance matching layers in accordance with a first embodiment of the present invention;

FIG. 2 shows the construction of a pressure measuring apparatus using an acoustic impedance matching layer in accordance with a second embodiment of the present invention, and

FIG. 3 shows a construction in which a reflection plate is disposed in the pressure measuring apparatus using the acoustic impedance matching layers in accordance with a third embodiment of the present invention.

### DETAILED DESCRIPTION OF THE PREFERRED EMBODIMENTS

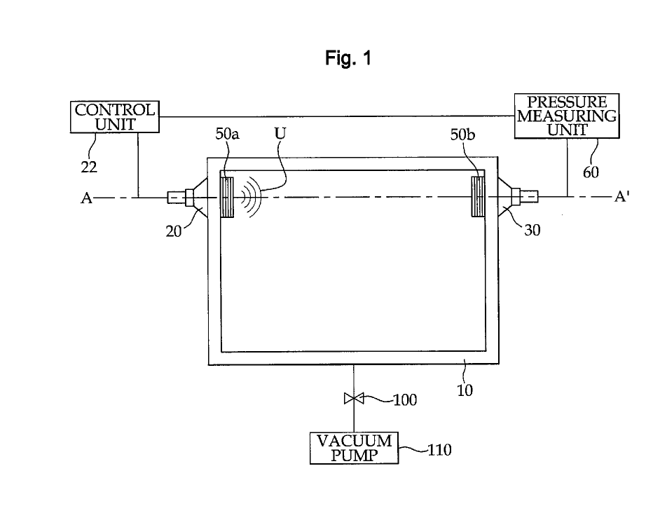

The present invention will now be described in detail in connection with specific embodiments with reference to the accompanying drawings. In FIGS. 1 to 3, reference numeral U denotes ultrasonic waves traveling inside a vessel 10, and reference numeral P denotes a path along which ultrasonic waves are reflected from an inner wall of the vessel 10 and travels.

### Construction of Pressure Measuring Apparatus

FIG. 1 shows the construction of a pressure measuring apparatus using acoustic impedance matching layers in accordance with a first embodiment of the present invention. As shown in FIG. 1, an ultrasound exciting unit 20 and an ultrasound receiving unit 30 are disposed at the outer surface of the vessel wall 10. The ultrasound exciting unit 20 and the ultrasound receiving unit 30 can employ an ultrasonic transducer comprised of a piezoelectric vibrator using a piezoelectric effect, an electrostrictive vibrator using electrostriction, a magnetostrictive acoustic vibrator, an electromagnetic vibrator or the like.

The ultrasonic transducer comprised of a piezoelectric vibrator (hereinafter referred to as a ‘piezoelectric ultrasonic transducer’) is configured to change electric field to mechanical deformation and thus generate ultrasonic waves, when an oscillating electric voltage is applied to a crystalline structure such as crystal, Rochell salt or ammonium dihydrogen phosphate (ADP), and can be used even in solid, liquid and gas media.

The ultrasonic transducer comprised of an electrostrictive vibrator (hereinafter referred to as an ‘electrostrictive ultrasonic transducer’) employs electrostriction, which is generated when an electric field is applied to dielectric material such as barium titanate (BaTiO₃), and is mainly useful for liquid media. The ultrasonic transducer comprised of a magnetostrictive acoustic vibrator (hereinafter referred to as a ‘magnetostrictive ultrasonic transducer’) employs a phenomenon in which, when a magnetic field is applied to ferromagnetic material, such as nickel, Terfenol-D, or iron-cobalt, the ferromagnetic material is magnetized, and therefore ultrasonic waves are generated by the deformation of the ferromagnetic material, and it is useful in solid, liquid, and gas media.

The ultrasonic transducer comprised of an electromagnetic vibrator (hereinafter referred to as an ‘electromagnetic ultrasonic transducer’) uses a voice coil type vibrator, such as a dynamic speaker, and is configured to vibrate surrounding media using an AC oscillator of a high frequency.

The ultrasound receiving unit 30 is preferably placed on the same axial line (A-A′) as that of the ultrasound exciting unit 20. Moreover, the ultrasound receiving unit 30 is driven in a reverse manner to the ultrasound exciting unit 20, and receives ultrasonic waves and converts the received ultrasonic waves into an electrical signal. Description of the ultrasound receiving unit 30 is identical to that of the ultrasound exciting unit 20.

First and second acoustic impedance matching layers 50a, 50b are attached to an inner surface of the vessel wall 10. That is, as shown in FIG. 1, the first and second acoustic impedance matching layers 50a, 50b are attached to the inner surface of the vessel wall 10, and the first acoustic impedance matching layer 50a is attached to face the ultrasound exciting unit 20. The second acoustic impedance matching layer 50b is further attached to the inner surface of the vessel wall 10 in such a way as to face the ultrasound receiving unit 30.

Each of the first and second acoustic impedance matching layers 50a, 50b has a predetermined thickness and can include a single layer or a plurality of layer with different acoustic impedance. The acoustic impedance of each of the first and second acoustic impedance matching layers 50a, 50b has a value between an acoustic impedance value of material of the vessel 10 and an acoustic impedance value of gas inside the vessel 10. The first acoustic impedance matching layer 50a functions to effectively transmit ultrasonic waves from the wall of the vessel 10 into gas inside the vessel, and the second acoustic impedance matching layer 50b functions to increase the transmitting efficiency of ultrasonic waves from gas inside the vessel into the wall of the vessel 10.

The first and second acoustic impedance matching layers 50a, 50b function to increase transmittance of the ultrasonic wave by acoustic impedance matching between the wall of the vessel 10, and gas in inside the vessel. This is because, in general, when an acoustic impedance difference between two media increases, the transmitting efficiency of ultrasonic waves decreases. The first and second acoustic impedance matching layers 50a, 50b can be fabricated in consideration of material of the vessel 10, the degree of vacuum or the range of pressure of the vessel 10 to be measured, a thickness of the vessel 10 and/or the like. That is, design parameters of the first and second acoustic impedance matching layers 50a, 50b can include acoustic impedance, a thickness, the attenuation ratio of ultrasonic energy, etc. of a single layer or each of a plurality of layers, which constitute each of the first and second acoustic impedance matching layers 50a, 50b, the number of layers constituting each of the first and second acoustic impedance matching layers 50a, 50b, and so on. Here, the thickness of each of the plurality of layers can be decided by taking the frequency of ultrasonic waves into consideration. The plurality of layers constituting each of the first and second acoustic impedance matching layers 50a, 50b can be fixed to an inner wall using adhesives, a press method employing a tool or the like. In the case in which adhesives or a tool is used, it is necessary to consider the acoustic impedance of the adhesives, a change in the thickness of each of a plurality of layers when the plurality of layers is pressed using the tool, etc.

A filter unit (not shown) is for removing various noise signals included in measured ultrasonic wave signals. The filter unit can be preferably added before an ultrasonic signal received by the ultrasound receiving unit 30 is applied to a pressure measuring unit 60. For example, the filter unit may employ a highpass filter (HPF) or a bandpass filter (BPF).

The pressure measuring unit 60 measures an internal pressure of the vessel 10 based on the excitation signal, which are transmitted into the ultrasound exciting unit 20, and an ultrasonic waves received by the ultrasound receiving unit 30 or/and the filter unit (not shown). The present invention is based on the principle that acoustic impedance of gas inside the vessel is changed according to an internal pressure. Accordingly, the pressure measuring unit 60 analyzes the received ultrasonic signal, calculates a change in the acoustic impedance of gas based on the amplitude, waveform and time of flight of the ultrasonic waves traveling inside the vessel 10, etc., and measures an internal pressure of the vessel 10 according to the acoustic impedance variation.

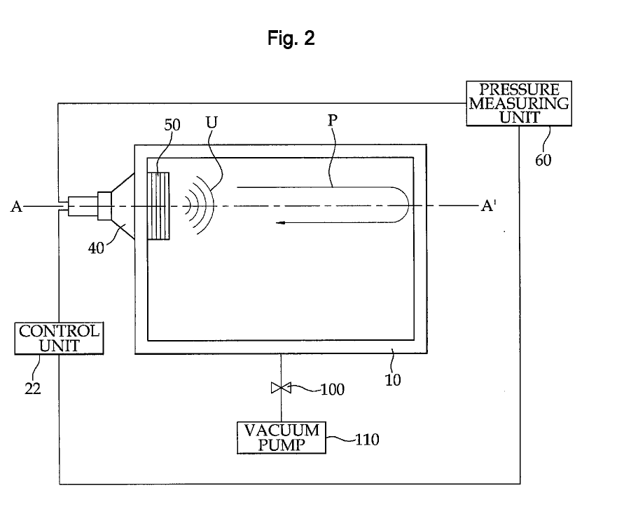

FIG. 2 shows the construction of a pressure measuring apparatus using an acoustic impedance matching layer in accordance with a second embodiment of the present invention. The pressure measuring apparatus using an acoustic impedance matching layer in accordance with a second embodiment of the present invention includes, as shown in FIG. 2, an ultrasound exciting/receiving unit 40, an acoustic impedance matching layer 50, and a pressure measuring unit 60.

The ultrasound exciting/receiving unit 40 is disposed at the outer surface of a vessel wall 10. The ultrasound exciting/receiving unit 40 is one device serving as the ultrasound exciting unit 20 and the ultrasound receiving unit 30 of the above first embodiment as described above, and can employ the piezoelectric ultrasonic transducer, the electrostrictive ultrasonic transducer, the magnetostrictive ultrasonic transducer, the electromagnetic ultrasonic transducer or the like. Ultrasonic waves, generated from the ultrasound exciting/receiving unit 40 into the inside of the vessel 10, travel inside the vessel 10. The traveling ultrasonic waves are reflected from an inner wall of the vessel 10 and then return back to the ultrasound exciting/receiving unit 40 according to a pulse-echo method.

The acoustic impedance matching layer 50 has the same construction as that of each of the first and second acoustic impedance matching layers 50a, 50b described in connection with the first embodiment, and the pressure measuring unit 60 is also identical to that of the first embodiment. Thus, description of the acoustic impedance matching layer 50 and the pressure measuring unit 60 is omitted for simplicity.

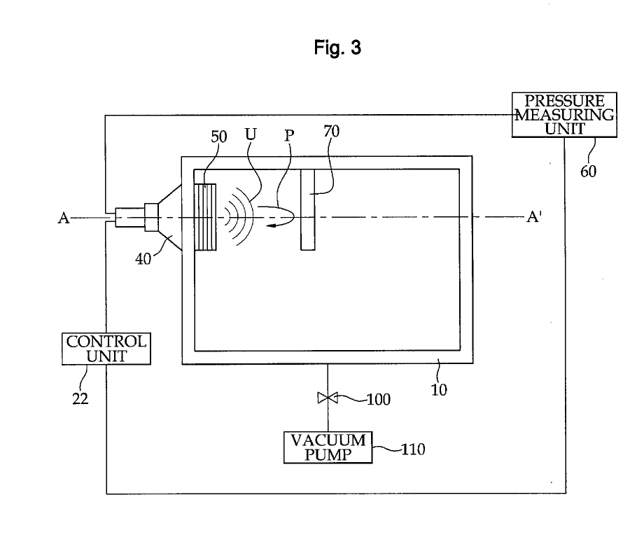

FIG. 3 shows a construction in which a reflection plate is disposed in the pressure measuring apparatus using the acoustic impedance matching layers in accordance with a third embodiment of the present invention. In the case in which an ultrasonic signal is received according to the pulse-echo method as shown in FIG. 3 like the second embodiment, a reflection plate 70 can be further disposed at a place close to an ultrasound exciting/receiving unit 40 in order to reduce attenuation of ultrasonic wave inside the vessel 10.

Unexplained reference numeral 22 denotes a control unit and functions to control ultrasonic waves, which are generated from the ultrasound exciting unit 20 of the first embodiment or the ultrasound exciting/receiving unit 40 of the second and third embodiments. When ultrasonic waves traveling inside the vessel 10 resonate between the first acoustic impedance matching layer 50a and the second acoustic impedance matching layer 50b (the first embodiment), between the acoustic impedance matching layer 50 and the inner wall of the vessel 10 (the second embodiment), and between the acoustic impedance matching layer 50 and the reflection plate 70 (the third embodiment), the transmitting efficiency of the ultrasonic waves increases. What the transmitting efficiency increases is meant that accuracy and resolution can be improved in measuring the internal pressure of the vessel 10. The control unit 22 applies a predetermined controlled excitation signal to the ultrasound exciting unit 20 or the ultrasound exciting/receiving unit 40 in order to induce resonance. Such resonance is useful when it is necessary to generate an ultrasonic signal of a high output, such as high-vacuum measurement.

Furthermore, unexplained reference numeral 110 denotes a vacuum pump for making the inside of the vessel 10 in a vacuum state, and unexplained reference numeral 100 denotes a valve used to produce vacuum. The above auxiliary devices are for making the inside of the vessel 10 in a vacuum state and are not indispensable constituent elements of the pressure measuring apparatus of the present invention.

### Pressure Measuring Method

A method of measuring an internal pressure of the vessel 10 using the pressure measuring apparatus of the present invention is described below.

First, as shown in FIGS. 1 to 3, the pressure measuring apparatus is installed (S10). The following steps are described per on an embodiment basis.

### First Exemplary Embodiment

The ultrasound exciting unit 20 and the ultrasound receiving unit 30 are adhered to the surface of the outer wall of the vessel 10. The ultrasound exciting unit 20, the ultrasound receiving unit 30, the first acoustic impedance matching layer 50a, and the second acoustic impedance matching layer 50b are placed, as shown in FIG. 1, on the same axial line (A-A′).

After the pressure measuring apparatus is installed, the control unit 22 is installed in order to control the excitation signal transmitted into the ultrasound exciting unit 20 (S20′). In order to increase the transmitting efficiency of the ultrasound receiving unit 30, it is preferred that the ultrasonic waves be controlled to resonate between the first acoustic impedance matching layer 50a and the second acoustic impedance matching layer 50b.

The ultrasonic waves generated from the ultrasound exciting unit 20 have its transmitting efficiency increased by the first acoustic impedance matching layer 50a attached to the inner surface of the vessel wall 10 and then travel inside the vessel 10 (S30′). Gas inside the vessel 10 has its acoustic impedance changed according to an internal pressure (that is, the density of the gas) of the vessel 10. Moreover, the amplitude, waveform, etc. of the ultrasonic waves are also changed according to the acoustic impedance of the gas.

The ultrasonic waves traveling inside the vessel 10 are received by the ultrasound receiving unit 30 (S40′). The transmitting efficiency of the ultrasonic waves, which are received by the second acoustic impedance matching layer 50b attached to the inner surface of the vessel wall 10, increases, so that the ultrasonic wave is sufficiently transmitted to the ultrasound receiving unit 30 disposed outside the vessel 10.

As a pressure measurement step, the ultrasonic signal received by the ultrasound receiving unit 30 is applied to the pressure measuring unit 60. The pressure measuring unit 60 compares the amplitude, waveform, frequency, etc. between the excitation signal, which is transmitted into the ultrasound exciting unit 20, and the ultrasonic signal received by the ultrasound receiving unit 30, and measures an internal pressure of the vessel 10 based on the amplitude, waveform and time of flight of the ultrasonic waves traveling inside the vessel 10 (S50′).

### Second Exemplary Embodiment

The ultrasound exciting/receiving unit 40 is adhered to the outer surface of the vessel wall 10 as shown in FIG. 2. The ultrasound exciting/receiving unit 40 and the acoustic impedance matching layer 50 are preferably placed on the same axial line (A-A′) in the same manner as the first embodiment.

After the pressure measuring apparatus is installed, the control unit 22 is installed in order to control the excitation signal transmitted into the ultrasound exciting/receiving unit 40 (S20″). This is for the purpose of increasing the transmitting efficiency by inducing resonance of the ultrasonic waves between the acoustic impedance matching layer 50 and the inner wall of the vessel 10.

The ultrasonic waves generated from the ultrasound exciting/receiving unit 40 have its transmitting efficiency increased by the acoustic impedance matching layer 50, which is attached to the inner surface of the vessel wall 10, and then travel inside the vessel 10 (S30″). Even in this case, in the same manner as the first embodiment, gas inside the vessel 10 has its acoustic impedance changed according to an internal pressure (that is, the density of the gas) of the vessel 10. The amplitude, waveform and time of flight, etc. of the ultrasonic waves are also changed according to the acoustic impedance of the gas.

However, the pulse-echo method is adopted in the second embodiment. Thus, the ultrasonic waves traveling inside the vessel 10 are reflected from the inner wall of the vessel 10 and are then received by the ultrasound exciting/receiving unit 40 (S40″). If the ultrasonic waves are received by the ultrasound exciting/receiving unit 40, the transmitting efficiency of the ultrasonic waves is increased by the acoustic impedance matching layer 50 as described above.

A next step is a pressure measurement step (S50″), which is identical to that of the first embodiment, and description thereof is omitted.

### Third Exemplary Embodiment

In the third embodiment, a step (S10) of installing the pressure measuring apparatus, a step (S20′″) of controlling the ultrasound exciting/receiving unit 40 using the control unit 22, a step (S40′″) of receiving ultrasonic waves, and a step (S50′″) of measuring pressure are identical to those of the previous embodiment, and description thereof is omitted.

A difference between the first and second embodiments lies in that, as shown in FIG. 3, the reflection plate 70 is further installed on the inner wall of the vessel 10. In this case, unlike the second embodiment, the propagation distance of ultrasonic waves becomes short, resulting in a difference in the amplitude and time of flight of received ultrasonic waves. However, since the reflection plate 70 is installed, attenuation of the ultrasonic wave decreases and accuracy in measuring pressure can be further improved.

Moreover, when the pressure measuring apparatus is installed (S10), the reflection plate 70 is installed in consideration of resonance conditions. For example, a place where the reflection plate 70 is installed can be a position where the wavelength λ of ultrasonic waves transmitted into the inside of the vessel 10 is ½ or a position where the wavelength λ of ultrasonic waves transmitted into the inside of the vessel 10 is a multiple

$$( \frac{λ}{2} n ) .$$

This is only an exemplary installation position of the reflection plate 70, but the construction of the present invention is not limited thereto.

As another embodiment of the present invention, the present invention can also be applied to a case where the vessel 10 has a high vacuum state of 10⁻⁵ to 10⁻⁹ Pa as well as a case where the vessel 10 has a low vacuum state of 1 to 10⁻⁵ Pa. The present invention can also be applied to a case where the vessel 10 has an atmospheric pressure state or higher.

As still another embodiment of the present invention, although the vessel 10 has been described above, the present invention can be applied to a case where an internal pressure of a specific vessel which does not has a vacuum state is to be measured. Further, the present invention can also be applied to a case where a vessel is filled with not gas, but solid or liquid.

As further still embodiment of the present invention, although the pressure measuring apparatus and method of the present invention have been described in relation to a vessel used in the semiconductor process or the LCD fabrication process, they can also be applied to all the industry fields in which the degree of vacuum, that is, the degree of pressure inside a specific vessel is to be measured.

In accordance with the pressure measuring apparatus using the acoustic impedance matching layer(s) according to the present invention, the acoustic impedance matching layer(s) is fixed to an inner surface of the vessel wall in order to increase the transmitting efficiency of ultrasonic waves for pressure measurement. Accordingly, there is an advantage in that accuracy can be improved even when pressure is measured without deformation of a vessel, such as punching.

Moreover, not only the acoustic impedance matching layer(s), but also the reflection plate are installed or resonance of ultrasonic waves is induced so as to increase the transmitting efficiency of ultrasonic waves. Accordingly, there is an advantage in that the degree of vacuum, that is, pressure inside a vessel can be measured even in a high pressure or high vacuum state using one pressure measuring apparatus.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. An apparatus for measuring pressure inside a vessel using acoustic impedance matching layers by employing ultrasonic waves, the apparatus comprising:
an ultrasound exciting unit attached to the outer surface of the vessel wall for generating ultrasonic waves to an inside of the vessel;
a first acoustic impedance matching layer attached to an inner surface of the vessel wall for increasing a transmitting efficiency of the ultrasonic waves from the vessel wall into gas inside the vessel;
an ultrasound receiving unit attached to the outer surface of the vessel wall for receiving the ultrasonic waves traveling inside the vessel;
a second acoustic impedance matching layer attached to the inner surface of the vessel wall for increasing transmitting efficiency of the ultrasonic waves from the gas inside the vessel into the vessel wall;
a control unit connected to the ultrasound exciting unit for controlling the excitation signal transmitted into the ultrasound exciting unit; and
a pressure measuring unit connected to the control unit for measuring an internal pressure of the vessel based on the excitation signal, which are transmitted into the ultrasound exciting unit, and an ultrasonic waves received by the ultrasound receiving unit.

2. The apparatus as claimed in claim 1, wherein the ultrasound exciting unit and the ultrasound receiving unit are placed on the same axial line.

3. The apparatus as claimed in claim 1, wherein the first acoustic impedance matching layer or the second acoustic impedance matching layer comprises a single layer or a plurality of layers with different acoustic impedance.

4. The apparatus as claimed in claim 1, wherein the first acoustic impedance matching layer or the second acoustic impedance matching layer has an acoustic impedance value between an acoustic impedance value of the vessel and an acoustic impedance value of gas inside the vessel.

5. The apparatus as claimed in claim 3, wherein the first acoustic impedance matching layer or the second acoustic impedance matching layer has an acoustic impedance value between an acoustic impedance value of the vessel and an acoustic impedance value of gas inside the vessel.

6. The apparatus as claimed in claim 1, wherein the control unit controls the excitation signal transmitted into the ultrasound exciting unit such that the ultrasonic waves generated from the ultrasound exciting unit resonate between the first acoustic impedance matching layer and the second acoustic impedance matching layer.

7. The apparatus as claimed in claim 1, wherein each of the ultrasound exciting unit and the ultrasound receiving unit comprises a piezoelectric ultrasonic transducer, a magnetostrictive ultrasonic transducer, an electromagnetic ultrasonic transducer or an electrostrictive ultrasonic transducer.

8. An apparatus for measuring pressure inside a vessel using an acoustic impedance matching layer by employing ultrasonic waves, the apparatus comprising:
an ultrasound exciting/receiving unit attached to the outer surface of the vessel wall, wherein the ultrasound exciting/receiving unit generates ultrasonic waves to an inside of the vessel and receives the ultrasonic waves, which are reflected from an inner wall of the vessel and then return back thereto;
an acoustic impedance matching layer attached to the inner surface of the vessel wall for increasing a transmitting efficiency of the ultrasonic waves between the vessel wall and gas inside the vessel;
a control unit coupled to the ultrasound exciting/receiving unit for controlling the excitation signal transmitted into the ultrasound exciting/receiving unit; and
a pressure measuring unit connected to the control unit for measuring an internal pressure of the vessel based on the excitation signal transmitted into the ultrasound exciting/receiving unit and an ultrasonic waves received by the ultrasound exciting/receiving unit.

9. The apparatus as claimed in claim 8, further comprising a reflection plate for reflecting the ultrasonic waves generated from the ultrasound exciting/receiving unit inside the vessel.

10. The apparatus as claimed in claim 8, wherein the ultrasound exciting/receiving unit comprises a piezoelectric ultrasonic transducer, a magnetostrictive ultrasonic transducer, an electromagnetic ultrasonic transducer or an electrostrictive ultrasonic transducer.

11. The apparatus as claimed in claim 8, wherein the acoustic impedance matching layer comprises a single layer or a plurality of layers with different acoustic impedance.

12. The apparatus as claimed in claim 8, wherein the acoustic impedance matching layer has an acoustic impedance value between an acoustic impedance value of the vessel and an acoustic impedance value of gas inside the vessel.

13. The apparatus as claimed in claim 11, wherein the acoustic impedance matching layer has an acoustic impedance value between an acoustic impedance value of the vessel and an acoustic impedance value of gas inside the vessel.

14. The apparatus as claimed in claim 8, wherein the control unit controls the excitation signal transmitted into the ultrasound exciting/receiving unit such that the ultrasonic waves generated from the ultrasound exciting/receiving unit resonate between the acoustic impedance matching layer and the inner wall of the vessel.

15. The apparatus as claimed in claim 9, wherein the control unit controls the excitation signal transmitted into the ultrasound exciting/receiving unit such that the ultrasonic waves generated from the ultrasound exciting/receiving unit resonate between the acoustic impedance matching layer and the reflection plate.
